(19) United States
(12) Patent Application Publication
(10) Pub. No.: US 2006/0283788 A1
(43) Pub. Date: Dec. 21, 2006

(54) Tri-clone system

(76) Inventor: Rudy Schreppel JR., Broken Arrow, OK (US)

Correspondence Address: RUDY SCHREPPEL . JR, 525 S LAUREL AVE., BROKEN ARROW, OK, 74012, US

(21) Appl. No.: 11/156,641

(22) Filed: Jun. 21, 2005

(51) Int. Cl. B01D 21/24

(52) U.S. Cl. 210/96.1; 210/512.1; 210/221.2; 210/521; 210/522; 210/101; 210/523; 210/187; 210/223

(57) ABSTRACT

A method for the remediation of contaminated liquid wherein contaminated or polluted waste water is treated in a process utilizing a three-fold filtration system wherein liquid is pumped into a tank divided by weirs to create three chambers comprising a three-fold filtration system wherein each chamber subjects polluted liquid to a series of swirl chambers, aeration, and settling means before being pumped out as clean water.

### BACKGROUND OF THE INVENTION

This application claims priority from provisional application No. 60/577,926 filed on Jun. 9, 2004. The invention relates to remediation of large quantities of liquid operating at low to moderate ambient pressures. Many time waste water streams from industrial process plants including but not limited to meat packing, rendering, and poultry processing plants operate at lower ambient pressures which make waste water contaminants more difficult to be removed.

Remediation is achieved through the use of swirl chambers that trigger hydrodynamic cavitation events in the liquid and the aeration and mixing of the liquid. These events drive chemical reactions, by generating strong oxidants and reductants, efficiently decomposing and destroying and separating contaminating organic compounds, as well as some inorganic material.

These same events both physically disrupt or rupture the cell walls or outer membranes of pollutants and also generate bactericidal compounds, such as peroxides and hydroxyl radicals among others that assist in the destruction of contaminating organisms upon disruption of the cell wall or outer membrane, the inner cellular components are more susceptible to oxidation and remediation.

There are many means for removing contaminants and inclusions from liquids, including filtration, stripping, adsorption, absorption, and ion exchange. In the case of organic contaminants, the ultimate end products of oxidation reactions are typically nontoxic substances such as water and carbon dioxide.

Oxidation reactions may be induced by a variety of means, such as the use of various chemicals, ozone, supercritical water, or photochemical oxidation where ultraviolet radiation is used to produce hydroxyl radicals, which are strong oxidizing agents. These methods are often costly. Oxidation reactions occur at both cavitation and aeration events.

The cavitation phenomenon results in the formation and collapse of micro-bubbles and is contained in the expanding diameter outlet body of a venturi. Cavitation may also be produced by a pump impeller or the force used to push liquid through an opening. Oxidation may also be by means of a “Rotometer” or like device. Aeration is typically delivered by means of submerged air diffusers within a tank.

The present invention achieves oxidation by employing a mechanism for generating a series of cavitation events in the bulk of the liquid utilizing one or more devices for creating a swirling action of the liquid that achieve cavitation results. This enables maximization of the, surface area of the cavities generated and of the volume of liquid subjected to cavitation and minimization of the power input required.

This process is very efficient in the treatment of polluted water, groundwater, wastewater, industrial process water, and drinking water. It could be employed as a stand-alone process or as a part of a treatment system.

This invention may be used in bottling plants, cooling towers, factories, green houses, hospitals, refineries, processing plants, mobile trailer parks, and any number of commercial municipalities or waste water treatment facilities.

### BRIEF SUMMARY OF THE INVENTION

The object of the invention is to provide a means for removing contaminants from liquids wherein the contaminants are concentrated and caused to pass directly through a collection passageway to an area where the components are removed.

The present invention further utilizes a three stage, or tri-clone separation means wherein swirl chambers and aeration creates a process that produces bubble formation and collapse in order to create localized high pressure. Wherein bubble implosion causes magneto-hydro-dynamics to occur which induces a magnetic charge to be imparted on a molecular scale.

In stage one, the liquid is first passed through a swirl chamber wherein the rotating flow is dispersed within the first chamber wherein oxidation and mixing occur; starting reactions which result in decomposition of contaminating compounds, thus triggering the physical destruction and decomposition of pollutants efficiently, effectively cleaning polluted waters or other liquids.

The swirl chamber includes a spiral passageway for the centrifugal flow of the influent material to be dispersed outwardly from the chamber. The swirl chamber typically includes a top cover and a bottom cover substantially closing the cylinder except for a central opening in the top cover for release of lighter materials and a central opening in the bottom cover for the heavy contaminants.

It is a related object of the invention to utilize the cavitational effects of the swirling liquid to cause the separation of fluids and pollutants by disruption of their cell walls or outer membranes. Said cavitational events also cause the chemical oxidation or reduction of organic and some inorganic contaminants, including the cellular components of destroyed microorganisms or larvae.

Liquid then flows into a second stage by gravity flow and is dispersed via a single swirl chamber. Liquid is then introduced to additional aeration for the maximum transfer of oxygen. Aeration conduits extend across the lower portion of the tank and within all three sections for the purpose of introducing diffusion bubbles and aeration. Said aeration means spaced for most effective dispersion of bubbles.

A skimming process may also takes place allowing oil and grease products to be removed. The skimmer blade is pivotally attached to the skimmer arm and includes resilient, flexible wiper blades that provide a substantially tight seam as it provides a trough leading to the receiving chamber. Heavier contaminants are removed from the bottom of the vessel.

The three stages are separated by baffles and weirs with directed openings allowing liquid to pass from one stage to the next. When required, fluid is slowed or otherwise delayed so that floc's can be maximized and if necessary flocking chemical can be added. Sludge or contaminates are collected in the bottom of the tank and when required back flushed using a hydraulic head if necessary.

The third stage provides additional aeration, separation and the outlet for the liquid. Thus the innovative tri-clone separator provides a non-chemical answer to problems of H2S, CO2, Ammonia, THM, TEC, and like contaminates. The tri-clone separator is completely self,-contained and can perform anywhere where flow lines have accessible plumbing.

Other objects and advantages will become apparent from a consideration of the ensuing description, claims, and accompanying drawings.

The invention as embodied herein provides a method and apparatus for forming multiple cavitating events within the liquid at a lower inlet pressures. The invention further includes chambers with diffusers spaced within each stage of the process to further induce aeration, friction and turbulence or the fluids.

### BRIEF DESCRIPTION OF THE DRAWINGS

FIG. 1 is a sectional view of the separator of this invention.

FIG. 2 is a top view with the cover removed

FIG. 3 is a sectional view taken from section A-A noted in FIG. 1

### DETAILED DESCRIPTION OF THE DRAWINGS

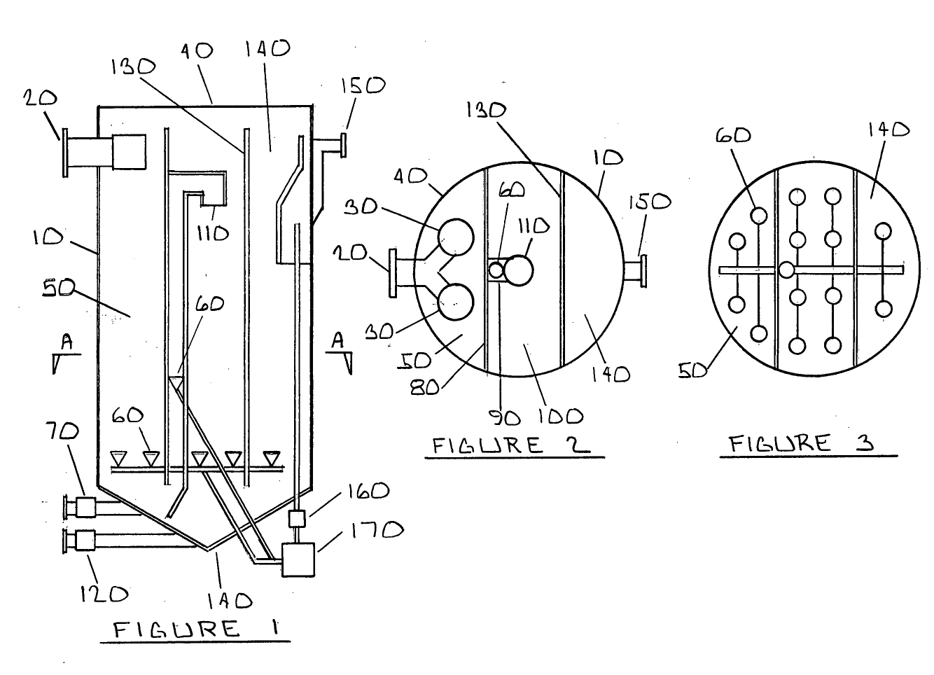

FIG. 1 shows the Tri-Clone Filtration System 10 and is schematically described herein. An influent stream of waste water containing contaminants is removed from the industrial process and introduced into inlet 20 where liquid is pumped to two separate swirl chambers 30 aligned on longitudinal axis and positioned equally within the first chamber 50 within tank 40. Swirl chamber 30 induces cavitation into the liquid and may be any commercially available product for the purpose for the induction of cavitation. The swirl chamber 30 may be sized as required to fit tank 40 size and diameter.

The fluid under pressure is directed through inlet port 20 and flows around the upstream portion of the swirl chamber 30 into an annular region between the internal and external wall and is evenly dispersed within tank 40 and within chamber 50 wherein the liquid is furthermore subjected and mixed by means of air diffuser nozzles 60 located at the lower portion of the tank 40.

Liquids are dispersed within tank 40 in the first chamber 50. Chamber 50 shall be the first of three separate chambers comprising the tri clone system. Contaminates within the liquid are forced to separate from said liquid within all three chambers and are collected at the bottom of tank 40 and are forced to outlet nozzle 70 and 120 by means of a cone 140 shaped within the bottom of tank 40.

Within tank 40 located near or above cone 140 are a series of air diffuser nozzles 60. Air diffusion nozzles 60 are located in each stage and in all three chambers within the tank 40. One example of the air diffusion nozzles 60 spacing configuration is shown in FIG. 3. Air diffusion nozzles 60 may have any number of deflectors, baffles, or shields in order to force water and air out at different degrees and direction.

Liquid within chamber 50 is then forced to flow by natural pressure or gravity under the first weir 80 through conduit 90 into the second chamber 100 through a centrally disposed swirl chamber 110 centered within tank 40 and located centrally within chamber 100. After liquid is forced through conduit 95 into swirl chamber 110 and into chamber 100,it is again subjected to aeration and mixing by means of air diffusion nozzles 60 thus causing contaminates to again fall into cone 140 to be removed by outlet 120. As fluids are passed from first chamber 50 to second chamber 100, an air diffusion nozzle 60 may be placed within the flow conduit 95 for additional diffusion and aeration of liquid.

Upon fluid being subjected to actions of chambers 50 and 100 the fluid flows into cone 140 under weir 130. Liquid is again subjected to aeration and mixing via air diffusion nozzles 60. Contaminates are again collected in cone 140 for removal via outlet valve 120 or outlet nozzle 70. The flow is then directed to outlet 150 as clean water.

As liquid flows out of outlet 150 a quantity of liquid shall be pumped back through a recycle pump 170. Said recycle pump 170 may additionally have any number of means placed within the flow of the pump for the purpose of injecting air back into air diffuser nozzles 60. One example of an air injection means may include a “Rotometer” or like device placed within the fluid flow or affixed to recycle pump 170.

The recycle pump 170 shall be adjustable and control the air diffusion nozzles 60 that are placed within the tank 40 within the chambers 50, 100, and cone 140 shown in FIG. 1 and FIG. 2.

The present invention is well suited to operation in a continuous decontamination and filtering systems. Systems may includes feed reservoir for receiving the flow of contaminated liquid through feed pipe as well as optionally receiving partially treated liquid from cavitation reaction chamber via recycle pump 170. Cavitation reaction chambers consist of a sealed chamber that may be operated at a moderately elevated pressure in which one or more swirling jet flows are produced.

Sampling ports may also be utilized to permit testing of the treated fluid in order to adjust the amount of chemicals and the recycle flow. Adjustment of the recycle flow may determine the residence time of the fluid in cavitation reaction chambers. Outlet nozzles 70 and 120 may enable treated liquid exiting cavitation reaction chamber to be recycled into feed reservoir for further treatment or to be removed from decontamination system.

Additionally when the contaminated material within the cone 140 is removed from the settling fluids by way of outlet nozzle 70 and/or 120. The incoming stream of contaminated fluid may additionally be caused to pass through at least one rotary drum screen Not Shown). In some instances, the stream is caused to pass through two or more rotary drum screens of decreasing mesh size opening. Chemical treatment compounds from a supply container (Not Shown) may be injected into the flow as needed.

In aqueous liquids it is believed that the dissociation of water to form hydroxyl radicals occurs under intense cavitation due to the growth and collapse of microscopic bubbles. Analogous dissociation of other molecules may occur as a result of cavitation in aqueous solutions as well as in non-aqueous liquids and solutions, producing radicals that similarly aid in the decontamination reactions described herein. Moreover, cavitation generated in any liquid environment will result in the physical disruption of contaminants, without regard to the generation of particular radicals.

The surface area of the cavities generated and the surface area-to-volume ratio are key parameters affecting the efficiency of the process, with larger surface areas and surface area-to-volume ratio resulting in higher decontamination efficiencies. This can be explained by the need to bring molecules of the contaminants to be oxidized (or reduced) into close proximity with the hydroxyl radicals, or high pressure and temperature regions, generated by the collapsing cavities. Increasing the overall cavity surface area in contact with the contaminated liquid increases the probability of the hydroxyl radicals and contaminants being close enough to react.

Additional valves, controls, and metering devices may also be added as needed for control of fluids and may be determined by each specific industry need.

Terms and expressions which have been employed in the forgoing specifications are used therein as terms of description and not of limitation, and there is no intention in the use of such terms and expressions of excluding equivalents of the features shown and described or portions thereof.

What is claimed is:

1. A method for the remediation of contaminated liquid wherein liquid is pumped into a tank divided by weirs to create three chambers comprising a three-fold filtration system wherein the first chamber has an inlet, two swirl chambers and aeration diffusers, the second chamber as a single swirl chamber and aeration diffusers and the third chamber has aeration diffusers and the outlet wherein liquid passes through all chambers and is subjected to cavitation and aeration means wherein contaminates are separated from liquid and settle to bottom of tank for removal and waste water is cleaned of contaminates for future use.

2. The method of claim 1 wherein said weirs are adjustable to thereby change flow.

3. The method of claim 1 wherein means are included to inject metered amounts of chemicals into fluids.

4. The method of claim 1 wherein said vessel is vertically cylindrical.

5. The method of claim 1 wherein skimmer blades are utilized for floating debris.

6. The method of claim 1 wherein second chamber has two or more swirl chambers.

7. The method of claim 1 wherein first chamber has only one swirl chamber.

8. The method of claim 1 wherein water jets is used instead of air diffusers.

9. The method of claim 1 wherein aeration is not used.

10. The method of claim 1 wherein tank is heated to assist process.

11. The method of claim 1 in which said liquid is water is heated prior to introduction into tank.

12. The method of claim 1 wherein oxidizing agents are fed into tank or stream.
